(19) United States
(12) Patent Application Publication
(10) Pub. No.: US 2018/0076727 A1
(43) Pub. Date: Mar. 15, 2018

(54) CONVERTER ARRANGEMENT AND METHOD FOR SHORT-CIRCUIT PROTECTION THEREOF

(71) Applicant: SIEMENS AKTIENGESELLSCHAFT, Munich (DE)

(72) Inventors: MARK-MATTHIAS BAKRAN, ERLANGEN (DE); ANDRE SCHOEN, ERLANGEN (DE); JIANG XU, BAYREUTH (DE)

(21) Appl. No.: 15/563,689

(22) PCT Filed: Apr. 2, 2015
(86) PCT No.: PCT/EP2015/057359

§ 371 Date: Oct. 2, 2017

(51) Int. Cl. H02M 5/458; H02M 1/32; H02M 7/49; H02M 7/483

(52) U.S. Cl. CPC H02M 5/4585; H02M 1/32; H02M 2007/4835; H02M 7/483; H02M 7/49

(57) ABSTRACT

A converter arrangement has phase module branches each with two-pole submodules having an energy storage device and a power semiconductor switch. The first phase module branch extends between a first alternating voltage connection and a first direct voltage pole, the second phase module branch extends between the first alternating voltage connection and a second direct voltage pole, the third phase module branch extends between a second alternating voltage connection and the first direct voltage pole, the fourth phase module branch extends between the second alternating voltage connection and the second direct voltage pole. Each submodule can be bridged, independently of the current direction, by a bridging unit. A direct voltage switch is connected between one of the direct voltage poles and the associated direct voltage connection, and a freewheeling path extends between the two direct voltage connections and has a semiconductor element with a blocking and a bypass direction.

The invention relates to a converter arrangement comprising a first phase module branch having a first series circuit containing two-pole submodules, which each comprise at least one energy store and at least one power semiconductor switching unit, wherein the first phase module branch extends between a first AC voltage connection and a first DC voltage pole, a second phase module branch having a second series circuit containing the two-pole submodules, wherein the second phase module branch extends between the first AC voltage connection and a second DC voltage pole, a third phase module branch having a third series circuit containing the two-pole submodules, wherein the third phase module branch extends between a second AC voltage connection and the first DC voltage pole, and a fourth phase module branch having a fourth series circuit containing the two-pole submodules, wherein the fourth phase module branch extends between the second AC voltage connection and the second DC voltage pole, wherein each submodule can be bypassed in a manner independent of current direction by means of a bypass unit arranged in parallel with the connection terminals of said submodule, and wherein the first DC voltage pole is connected to a first DC voltage connection and the second DC voltage pole is connected to a second DC voltage connection.

Bypassing in a manner independent of current direction is intended to exist here when the submodule is bypassed independently of the current direction.

The DC voltage connections are usually provided to connect the converter arrangement to a DC voltage line. The connections between the DC voltage poles and the associated DC voltage connections can accordingly be breakable connections.

A converter arrangement of the generic type is known from the article “Protection of Nonpermanent. Faults on DC Overhead Lines in MMC-Based HVDC Systems” by Li et al, IEEE Trans. On Power Delivery, Vol. 28, NO. 1, January 2013.

Converter arrangements of this type are used, for example, in high-voltage DC (HVDC) transmission. In this case, electric power can be transmitted efficiently over long distances of hundreds and thousands of kilometers. The transmission usually takes place via DC voltage lines, which are realized in the form of underground or underwater cables or overhead lines. In the latter case, in particular, environmental influences, such as lightning strikes and fallen trees, for example, can cause an often temporary short circuit in the DC voltage line. In the event of such DC-voltage-side faults, very high short-circuit currents potentially occur. The short-circuit currents can lead to damage in converter components as said short-circuit currents generally also flow through the phase module branches of the converter arrangement. This results in a need to disconnect the short-circuit currents for short-circuit protection of the converter arrangement. In the known converter arrangement, all of the power semiconductor switches in the submodules are closed as soon as a DC-voltage-side short circuit is detected by means of a suitable detector. At the same time, all the submodules are bypassed or their terminals are shorted by means of the associated bypass units, which, in the known converter arrangement, comprise antiparallel thyristors. To that end, a control unit provided for this purpose actuates the thyristors to change them to a conductive state. In this way, it is possible to cause, on the AC voltage side, a kind of symmetrical short circuit for all the phases of an AC voltage grid that is connected to the converter arrangement. This achieves a situation in which no more power is fed into the DC voltage line connected on the DC voltage side to the converter arrangement. The short-circuit current in the DC voltage line is thus no longer maintained by power transmission. The short-circuit current still flowing on account of line inductances in the DC voltage line then completely subsides.

Proceeding from the known converter arrangement, the object of the invention is that of further improving the short-circuit protection of the converter arrangement.

In a converter arrangement of the generic type, the object is achieved by a DC voltage switch, which is arranged between the first DC voltage pole and the first DC voltage connection or between the second DC voltage pole and the second DC voltage connection, and a freewheeling path, which extends between the two DC voltage connections and comprises a semiconductor element having a reverse and a forward direction.

The invention comprises both two-phase and three-phase and also polyphase embodiments. In this case, in a three-phase embodiment, the converter arrangement has, for example, a fifth and a sixth phase branch, which are arranged in the manner of the known converter arrangement.

In accordance with the invention, it is of course possible to connect both the first. DC voltage pole and the second DC voltage pole to the associated DC voltage connections by means of at least one DC voltage switch in each case.

The first DC voltage pole can be realized, for example, as a positive busbar and the second DC voltage pole can be realized, for example, as a neutral conductor. It is also conceivable for the first DC voltage pole to be realized as a neutral conductor and for the second DC voltage pole to be realized as a negative busbar. Further variants are also accordingly possible, such as, for example, the first DC voltage pole being at a positive and the second DC voltage pole being at a negative high-voltage electrical potential. The converter arrangement according to the invention can furthermore be part of a bipolar high-voltage DC (HVDC) transmission installation.

One advantage of the converter arrangement according to the invention is that the DC voltage switch can be used to commutate the short-circuit current flowing in the DC voltage line after the submodules have been bypassed onto the freewheeling path. In this way, advantageously, the DC-voltage-side short-circuit current does not then flow through the phase module branches of the converter arrangement, which improves the protection thereof as a result.

By combining the bypass units and the DC voltage switch, it is advantageously no longer necessary to configure the DC voltage switch or the reverse voltage thereof to switch at full DC-voltage-side voltage. Instead, it is sufficient for the DC voltage switch to be configured merely to commutate the short-circuit current onto the freewheeling path. For example, instead of a reverse voltage of 320 kV, a reverse voltage of 10 kV may now be sufficient. As a result, the power electronics circuit complexity for the DC voltage switch is advantageously reduced. In addition, the losses in normal operation of the converter arrangement are relatively low.

The bypass unit appropriately comprises a bypass branch, which is arranged in parallel with the two connections or poles of the submodules, with the result that a short circuit can be caused at the connections independently of the current direction. The bypass unit can be connected to a control device by means of which the bypass unit can be controlled and which can thus, in particular, initiate the bypassing of the submodules. The bypass unit preferably comprises antiparallel-connected thyristors. The thyristors are fired simultaneously in order to bypass the submodules in a manner independent of current direction. A particularly advantageous and reliable bypass unit is provided in this way.

To detect a short circuit in the DC voltage line, it is possible to provide a detection device, for example a current measurement device, which is connected on the output side to the control device, for example.

In accordance with one advantageous embodiment of the invention, the semiconductor element in the freewheeling path comprises at least one diode and/or a thyristor. The diode and/or the thyristor prevents a short circuit between the two DC voltage poles of the DC voltage line in normal operation of the converter arrangement. The thyristor is appropriately fired in the event of a short circuit, in order to facilitate the short-circuit current via the freewheeling path. The freewheeling path appropriately has a polarity opposite to a rated potential. In this way, in accordance with the selected forward direction of the diode, essentially no current is carried by the freewheeling path in normal operation of the converter arrangement. The semiconductor element can also be formed by a series circuit containing a plurality of diodes and/or thyristors.

In addition to the semiconductor element, an energy absorber is preferably arranged in the freewheeling path, wherein the energy absorber is arranged in series with the semiconductor element. The energy absorber, which can be a resistance element, for example, is configured to divert the energy of the short-circuit current, for example by converting it to heat. A faster subsidence of the short-circuit current in the DC voltage line can be brought about in this way.

The energy absorber can also comprise a surge arrester or a series circuit containing surge arresters. An embodiment of this type has the advantage that additional protection of the converter arrangement is provided.

The submodules of the converter arrangement can all be of the same type of design, but do not necessarily have to be.

The submodules are preferably embodied as half-bridge circuits. Half-bridge circuits of this type are described, for example, in DE 101 03 031 B4. Submodules of this type are particularly cost-effective in operation on account of the relatively low losses. The power semiconductor switches of the submodules are power semiconductors that can be turned off in an appropriate manner, such as IGBTs, GTOs or the like, for example.

In accordance with one embodiment of the invention, the DC voltage switch comprises at least one power semiconductor switching module having a power semiconductor switch. The power semiconductor switch is, for example, what is known as a solid-state switch having an integrated-gate bipolar transistor (IGBT), with which a freewheeling diode is connected in antiparallel.

The DC voltage switch can comprise a series circuit containing a plurality of power semiconductor switching modules of this kind. The number of power semiconductor switching modules in the series circuit is adapted appropriately to the respective application. In the event of a short circuit, the power semiconductor switching modules are switched off, for example by means of a control system configured for that purpose, with the result that the short-circuit current can commutate onto the freewheeling path.

The DC voltage switch preferably has a series circuit composed of the at least one power semiconductor switching module and at least one isolating switch. The isolating switch can be a mechanical switch. The DC voltage line can be interrupted by means of the isolating switch after the current in the isolating switch has subsided. After the isolating switch has been opened, the AC-voltage-side short-circuit current can also be interrupted in a simple manner, for example by closing the bypass units.

The DC voltage switch can further comprise at least one surge arrester. The at least one surge arrester can be arranged, for example, with the, which in parallel with the at least one power semiconductor switching module or the series circuit containing power semiconductor switching modules. The surge arrester restricts the voltage dropped across the power semiconductor switching modules and can furthermore be used as an energy-absorbing element.

As already explained above, the dielectric strength or blocking ability of the DC voltage switch of the converter arrangement according to the invention does not have to be configured for a DC-voltage-side rated voltage value, that is to say the voltage dropped between the two DC voltage connections during normal operation. The dielectric strength of the DC voltage switch is preferably less than 40%, preferably between 5% and 20%, of the rated voltage value.

This reduces the electrical losses and hence the operating costs of the converter arrangement.

The invention further relates to a method for the short-circuit protection of the converter arrangement according to the invention.

The object of the invention therefore consists in proposing such a method that is as simple and reliable as possible.

The invention achieves this object by way of a method in which, in the event of a DC-voltage-side short circuit, all submodules are bypassed in a manner independent of current direction, whereupon the DC voltage switch is turned off, with the result that a DC-voltage-side short-circuit current is commutated onto the freewheeling path.

In the method according to the invention, in the event of a DC-voltage-side short circuit, an AC-voltage-side short circuit is thus created in the converter arrangement by means of the bypass units, whereupon the short-circuit current from the phase module branches of the converter arrangement is actively commutated onto the freewheeling path by means of the DC voltage switch.

The advantages of the method according to the invention can be gathered from the previously described advantages of the converter arrangement according to the invention.

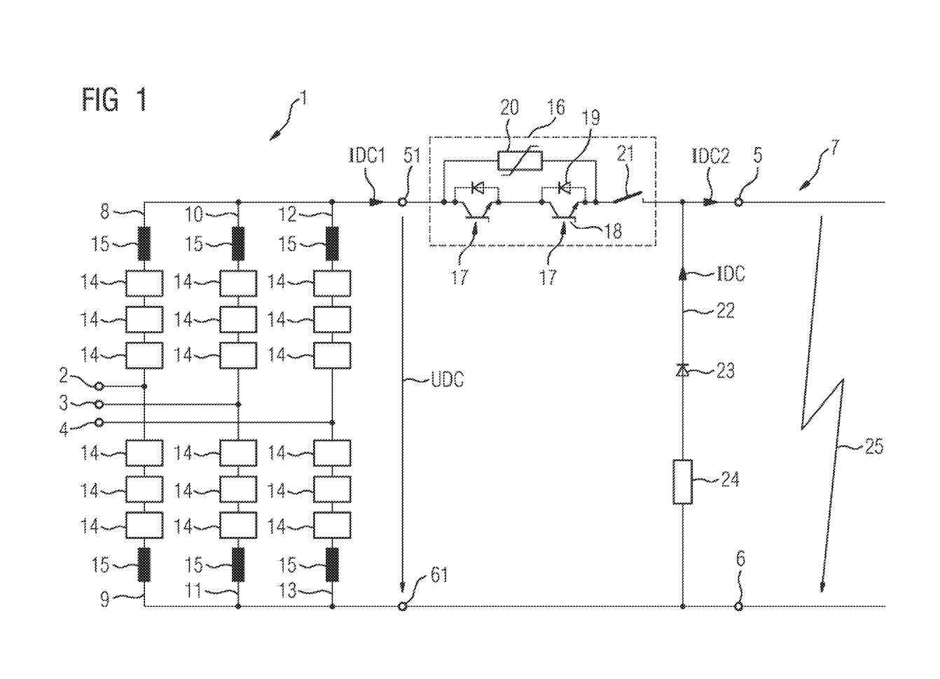

In the following text, the invention will be explained in greater detail with reference to FIGS. 1 to 3.

FIG. 1 shows a schematic illustration of an exemplary embodiment of a converter arrangement according to the invention;

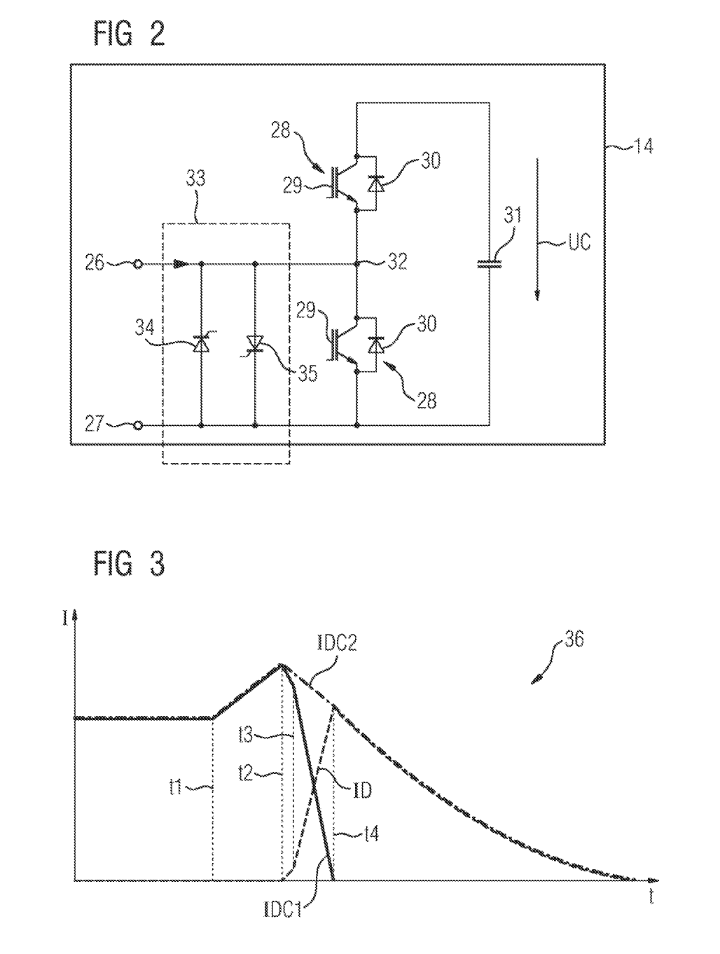

FIG. 2 shows a schematic illustration of a two-pole submodule of the converter arrangement of FIG. 1;

FIG. 3 shows the schematic profile of currents in the converter arrangement of FIG. 1.

FIG. 1 illustrates an exemplary embodiment of a converter arrangement 1 according to the invention in detail. The converter arrangement 1 comprises three AC voltage connections 2, 3 and 4, which are configured to connect the converter arrangement 1 to a three-phase AC voltage grid. The converter arrangement 1 further comprises a first DC voltage connection 5 and a second DC voltage connection 6 for connection to a DC voltage line 7. In the present exemplary embodiment, the converter arrangement 1 is accordingly of three-phase design, wherein the invention is obviously not restricted to a three-phase embodiment. Said converter arrangement comprises a first phase branch 8, which extends between a first DC voltage pole 51 and the first AC voltage connection 2, a second phase module branch 9, which extends between the first AC voltage connection 2 and a second DC voltage pole 61, a third phase module branch 10, which extends between the first DC voltage pole 51 and a second AC voltage connection 3, a fourth phase module branch 11, which extends between the second AC voltage connection and the second DC voltage pole 61, a fifth phase module branch 12, which extends between the first DC voltage pole 51 and the third AC voltage connection 4, and a sixth phase module branch 13, Which extends between the third AC voltage connection 4 and the second DC voltage pole 61.

The first DC voltage pole 51 is connected to the first DC voltage connection 5. The second DC voltage pole 61 is connected to the second DC voltage connection 6.

The first phase module branch 8 comprises a first series circuit containing two-pole submodules 14 and a smoothing inductor 15 arranged in series with the series circuit containing the two-pole submodules 14. The phase module branches 9, 10, 11, 12, 13 each accordingly comprise a series circuit containing the submodules 14 and a smoothing inductor 15 connected in series therewith. In the exemplary embodiment of the converter arrangement 1 illustrated in FIG. 1, each of the phase module branches 8-13 has three submodules 14. However, the number of submodules 14 in each phase module branch is generally adapted to the respective application of the converter arrangement 1 and can be any desired number.

In the exemplary embodiment illustrated in FIG. 1, all the submodules 14 of the converter arrangement 1 are of the same type of design. The phase module branches 8-13 together with the AC voltage connections 2-4 and the DC voltage connections 5, 6 accordingly form what is known as a modular multilevel converter (MMC). A converter of this type is known, for example, from DE 10 103 031 94. A predetermined voltage can be generated in the phase module branches 8-13 by means of a suitable control system (not illustrated in FIG. 1), with the result that a voltage UDC is dropped on the DC voltage side of the phase module branches 8-13.

The converter arrangement 1 further comprises a DC voltage switch 16, which is arranged between a potential point 51, between the first phase module branch 8 and the third phase module branch 10, and the first DC voltage connection 5. The DC voltage switch 16 has a series circuit containing power semiconductor switching modules 17, wherein each power semiconductor switching module 17 has an IGBT 18 and a freewheeling diode 19 connected in antiparallel therewith. A surge arrester 20 is arranged in parallel with the power semiconductor switching modules 17. An isolating switch 21 is further arranged in series with the power semiconductor switching modules 17, said isolating switch being a mechanical switch in the exemplary embodiment illustrated.

The converter arrangement 1 further comprises a freewheeling path 22. The freewheeling path 22 is arranged in parallel with the phase module branches 8-13 and extends between the two DC voltage connections 5, 6. The freewheeling path further has a semiconductor element 23, which is realized as a semiconductor diode. Furthermore, the freewheeling path 22 has an energy absorber 24, which is arranged in series with the semiconductor element 23.

A converter arrangement 1 of this type can b e protected against damage, in particular, in the event of a DC-voltage-side short circuit. The short circuit is indicated in FIG. 1 by the jagged line 25.

The subsequent figures will deal with the mode of operation of the converter arrangement 1 and the protection function thereof in more detail, wherein the current through the DC voltage switch 16 is denoted IDC1, the current in the DC voltage line 7 is denoted IDC2 and the current in the freewheeling path 22 is denoted ICD.

The submodules 14 of the converter arrangement 1 of FIG. 1 are realized as half-bridge circuits.

FIG. 2 shows the basic design of one of the submodules 14 of the converter arrangement 1 of FIG. 1. The submodule 14 comprises a first connection terminal 26 and a second connection terminal 27. The submodule 14 further comprises two power semiconductor switching units 28 connected in series. Each of the two power semiconductor switching units 28 comprises a power semiconductor switch 29, which, in the exemplary embodiment illustrated in FIG. 2, is an IGBT, and a freewheeling diode 30 connected in antiparallel therewith. An energy store 31 is arranged in parallel with the series circuit containing power semiconductor switching units 28, said energy store being a power capacitor in the present exemplary embodiment of the submodule 14. A voltage that is denoted UC in FIG. 2 is dropped at the power capacitor 31.

The second connection terminal 27 of the submodule 14 is connected to a pole of the power capacitor 31, the first connection terminal 26 of the submodule 14 is connected to a potential point 32 between the two power semiconductor switching units 28.

The submodule 14 further comprises a bypass unit 33, which is connected to the connections 26, 27 in such a way that it can bypass the submodule 14 or can short the two connection terminals 26, 27. The bypass unit 33 has two antiparallel-connected thyristors 34 and 35, which can provide bypassing of the submodule 40 in a manner independent of current direction. In order to bypass the submodule 14, the two thyristors are actuated to fire at the same time by means of a control unit (not illustrated).

FIG. 3 shows a sketch of the time profiles of the three currents IDC1, IDC2 and ID of the exemplary embodiment of the converter arrangement of FIG. 1 in a graph 36. The elapsed time is plotted on the abscissa t of the graph 36 and the current values at given times are plotted on the ordinate I. The current direction of the three currents IDC1, IDC2, ID in normal operation is indicated in FIG. 1 by corresponding arrows.

A fault, for example a short circuit in the DC voltage line 7, occurs at an instant that is distinguished in the graph 36 as a discontinuous line t1. From this instant, the currents IDC1 and IDC2 increase. The values of the currents IDC1 and IDC2 are the same up to an instant distinguished freewheeling path essentially has no current in normal operation on account of the polarity of the diode 23 counter to the rated potential present in normal operation.

At the instant denoted t2, the fault is detected by means of a suitable fault recognition device. Consequently, all bypass units 33 in the phase module branches 8 to 13 are actuated to bypass the submodules 14 associated with them, that is to say the thyristors 34 and 35 are fired in each submodule 14. In this way, the phases of the AC voltage grid connected on the AC voltage side to the AC voltage connections 2, 3, 4 are shorted. In other words, the AC voltage grid is isolated from the DC voltage side with the result that the short-circuit current can no longer be fed from the AC voltage grid, that is to say can no longer be supplied with power. The values of the currents IDC1 and IDC2 decrease from this instant.

At an instant distinguished by the discontinuous line t3, the power semiconductor switches 18 of the power semiconductor switching modules 17 are actuated to turn off.

The current is commutated onto the freewheeling path 22 on account of the reverse voltage of the power semiconductor switches 17 with the aid of the surge arrester 20, which can also be realized as a series circuit containing surge arresters. The value of the current IDC1 decreases very quickly to zero from this instant.

As soon as IDC1 has decreased to zero or almost to zero, which in FIG. 3 occurs at an instant indicated by a discontinuous line denoted t4, the mechanical isolating switch 21 can be opened. The remaining short-circuit current ID in the DC voltage line 7, whose value then corresponds to the value of the current IDC2, flows entirely along the freewheeling path 22 from this instant. ID subsides in accordance with an RL constant of the DC voltage line 7. The subsidence of the current ID is additionally accelerated by the energy absorber 24.

1-10. (canceled)

11. A converter arrangement, comprising:
a first phase module branch having a first series circuit containing a plurality of two-pole submodules each including at least one energy storage device and at least one power semiconductor switch, wherein said first phase module branch extends between a first AC voltage connection and a first DC voltage pole;
a second phase module branch having a second series circuit containing a plurality of two-pole submodules, wherein said second phase module branch extends between the first AC voltage connection and a second DC voltage pole;
a third phase module branch having a third series circuit containing a plurality of two-pole submodules, wherein said third phase module branch extends between a second AC voltage connection and the first DC voltage pole,
a fourth phase module branch having a fourth series circuit containing a plurality of two-pole submodules, wherein said fourth phase module branch extends between the second AC voltage connection and the second DC voltage pole,
each said submodule having connection terminals and a bypass unit connected in parallel with said connection terminals, said bypass unit enabling said submodule to be bypassed independently of a current direction, and wherein the first DC voltage pole is connected to a first DC voltage connection and the second DC voltage pole is connected to a second DC voltage connection;
a DC voltage switch connected between the first DC voltage pole and the first DC voltage connection or between the second DC voltage pole and the second DC voltage connection; and
a freewheeling path extending between the first and second DC voltage connections, said freewheeling path including a semiconductor element having a reverse direction and a forward direction.

12. The converter arrangement according to claim 11, wherein said bypass unit comprises antiparallel-connected thyristors.

13. The converter arrangement according to claim 11, wherein said semiconductor element in said freewheeling path comprises at least one element selected from the group consisting of a diode and a thyristor.

14. The converter arrangement according to claim 11, which comprises an energy absorber connected in series with said semiconductor element in said freewheeling path.

15. The converter arrangement according to claim 11, wherein said submodules are half-bridge circuits.

16. The converter arrangement according to claim 11, wherein said DC voltage switch comprises at least one power semiconductor switching module having a power semiconductor switch.

17. The converter arrangement according to claim 16, wherein said DC voltage switch has a series circuit composed of said at least one power semiconductor switching module and at least one isolating switch.

18. The converter arrangement according to claim 16, wherein said DC voltage switch comprises a surge arrester connected in parallel with said at least one power semiconductor switching module.

19. The converter arrangement according to claim 11, wherein said DC voltage switch has a dielectric strength that is lower than 40% of a DC-voltage-side rated voltage value of the converter arrangement.

20. A method for a short-circuit protection of a converter arrangement, the method comprising:
providing a converter arrangement according to claim 11 and, on occasion of a DC-voltage-side short circuit:
bypassing all submodules of the converter arrangement independent of a current direction; and
subsequently turning off the DC voltage switch to cause a DC-voltage-side short-circuit current to be commutated onto the freewheeling path.
